(19) United States
(12) Patent Application Publication
(10) Pub. No.: US 2008/0169003 A1
(43) Pub. Date: Jul. 17, 2008

(54) FIELD REACTIVE AMPLIFICATION CONTROLLING TOTAL ADHESION LOADING

(75) Inventor: STEVEN A. CURTIS, Dayton, MD (US)

Correspondence Address: NASA GODDARD SPACE FLIGHT CENTER, 8800 GREENBELT ROAD, MAIL CODE 140.1, GREENBELT, MD, 20771, US

(73) Assignee: NASA Headquarters, Washington, DC (US)

(21) Appl. No.: 11/870,190

(22) Filed: Oct. 10, 2007

Related U.S. Application Data
(60) Provisional application No. 60/885,296, filed on Jan. 17, 2007.

(51) Int. Cl. C25F 1/00; B05B 5/053; G01N 1/00; B08B 7/00

(52) U.S. Cl. 134/1; 361/226; 73/863.21; 977/899

(57) ABSTRACT

Systems and methods are provided through which in some embodiments for controlling intermolecular forces between a contact surface and a fabricated microstructure having a base and at least one or more nano-structures. The contact surface and the fabricated microstructure are joined by the interplay of electrostatic and van der Waals forces. The contact surface can be planetary dust with surfaces involved in planetary exploration, as well as synthetic gecko hairs that would allow small robots to climb walls and traverse ceilings. The system and method allow intense electrostatic forces to be applied at variable levels in order to modulate the effectiveness of van der Waals forces as well as external electrostatic forces. This device enables advanced small robot mobility, planetary dust control at all possible ambient pressures, as well as dust sample collection for exploration analysis.

### ORIGIN OF THE INVENTION

The invention described herein was made by an employee of the United States Government and may be manufactured and used by or for the government for government purposes without payment of any royalties thereon or therefore.

### FIELD OF THE INVENTION

This invention relates generally to controlling intermolecular forces on a contact surface, and more particularly to a device that will allow small robot mobility, planetary dust control, and dust sample collection for exploration analysis.

### BACKGROUND

The advances in nanotechnology fabrication have made it possible to construct very intricate structures with fractal or dendritic architecture. This structure can be fashioned to simulate the adhesive mechanisms of some biological systems. The pad of a gecko's foot is comprised of hundreds of thousands of setae, which give them remarkable ability to climb and adhere to surfaces of many different kinds, including smooth hydrophobic and hydrophilic surfaces. Setae are small hairs that split into hundreds of much smaller hairs, nanometers in diameter, called spatula. The adhesive force of the gecko is due to intermolecular forces caused by the individual spatula with a surface. These intermolecular forces, commonly known as Van der Waals forces, are weak attractive forces between atoms or non-polar molecules caused by a temporary change in dipole moment arising from a brief shift in orbital electrons to one side of one atom or molecule, creating a similar shift in adjacent atoms or molecules. Although Van der Waals forces are relatively weak, the spatulae are so small and so many in number that the aggregate force is very strong.

In a collection of slender hairs planted on a solid surface, the forces between neighboring fibers can cause them to bundle together and to become a collector for dust and other particles. Dust collecting and bunching of the hairs is a problem that reduces the adhesive properties of the gecko.

For at least the reasons stated above and for other reasons stated below, which will become apparent to those skilled in the art upon reading and understanding the present specification, there is a need in the art for a control mechanism that modulates the effectiveness of net forces, such as van der Waals forces and external electrostatic forces acting on microstructures. There is also a need for a device that can perform dust sample collecting or dust control.

### SUMMARY

The above-mentioned shortcomings, disadvantages, and problems are addressed herein, which will be understood by reading and studying the following specification.

The interplay of electrostatic and van der Waals forces play a crucial role not only in everyday surface-environment interactions, but also more particularly in the interaction of planetary dust with surfaces involved in planetary exploration, especially on the Moon, as well as in adhesion and stability aspects of synthetic gecko hairs that would allow small robots to climb walls and traverse ceilings. The invention is to applying an electrostatic field to nano hairs so as to modulate the effectiveness of van der Waals forces and external electrostatic forces at the tip of the nano hairs. This device enables advanced small robot mobility, planetary dust control at all possible ambient pressures, as well as dust sample collection for exploration analysis.

In one aspect, an apparatus for controlling intermolecular forces at a contact surface includes a fabricated microstructure having a base with at least one or more nano-structures disposed on at least one or more portions of the base to adhere to the contact surface; the nano-structures have variable lengths and are anchored to the base; and a generator for imparting a variable electric field at the base to control the intermolecular forces between the nano-structures and the contact surface.

In another aspect, the nano-structures form a fractal or dendritic architecture of needle-like points and the one or more nano-structures adhere to the contact surface by intermolecular forces, such as van der Waals forces and electrostatic forces.

In yet another aspect, the imparted variable electric field is amplified as it travels from the base to a tip of a needle-like point causing a reduction in the intermolecular forces.

In still another aspect, a method for sampling one or more particles include trapping the at least one or more particles in a fabricated microstructure; the microstructure has a base and at least one or more nano-structures disposed on one or more portions of the base to adhere to the at least one or more particles through intermolecular forces formed between the at least one or more nano-structures and the one or more particles; imparting a variable electric field at the base; the imparted electric field controls the intermolecular forces between the nano-structures and the one or more particles.

In a further aspect, a method for cleaning a surface having particulate matter thereon. The surface is a fabricated microstructure having a base and one or more nano-structures disposed on one or more portions of the base; the nano-structures have variable lengths and are anchored to the base. The intermolecular forces between the nano-structures and the particulate matter is controlled by imparting an electric field at the base.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 illustrates a fabricated microstructure with nano-structures in accordance to a first embodiment;

FIG. 2 illustrates nano carpet or nano hairs in accordance to another exemplary embodiment;

FIG. 3 illustrates nano carpet or nano hairs with an applied potential in accordance to an embodiment;

FIG. 4 illustrates electric field amplification for an n-step nano hair structure in accordance to an embodiment;

FIG. 5 is a block diagram of a hardware and operating environment in which different embodiments can be practiced;

FIG. 6 is a flowchart of a method for controlling intermolecular forces in accordance to an embodiment; and

FIG. 7 is a flowchart of a method for sampling particles in accordance to an embodiment.

### DETAILED DESCRIPTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

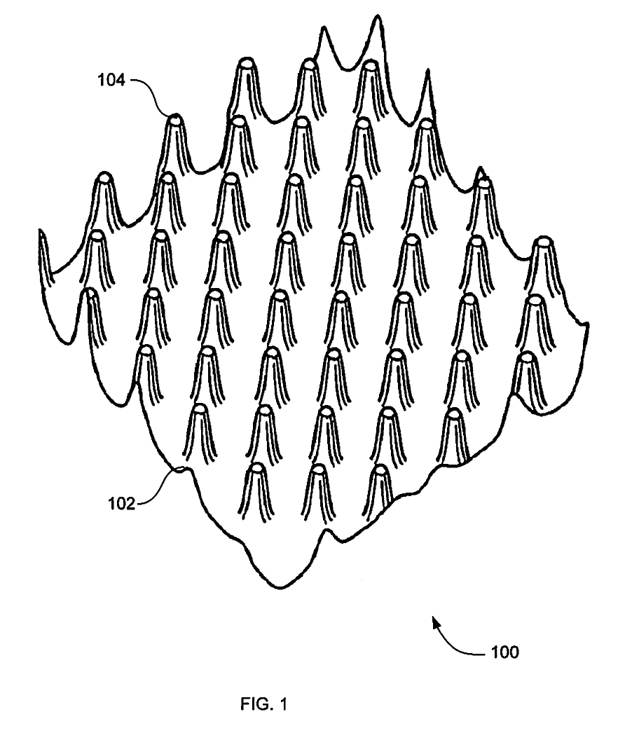

FIG. 1 illustrates a fabricated microstructure 100 with nano-structures 102 in accordance to an embodiment. The microstructure has a base 102 that includes nano-structures 104 attached at one portion of base 102. It should be recognized that nano-structures 104 can be a single structure or a plurality of structures, such as plates, spheres, spikes, or needles. In the present exemplary embodiment nano-structures 104 adhere to a contact surface such as dust, particles, wall, plate, or rock. The surface establishes an adhesive connection, the contact surface (dust, particle, gecko hair, or nano hair) touches the surface of the respective other object (nanostructure, nano hair) without establishing an anchorage and without any interlocking of the projections. The adhesive connection is achieved by van der Waals forces. Additional contributions can be made by electrostatic forces or capillary forces. The spacing between the projections is smaller than the cross-sectional dimensions of the front surfaces. The nano-structure 104 uses intermolecular forces, and, in particular, a net force resulting from a combination of van der Waals forces and electrostatic forces to adhere to a surface. The adhesive strength between the tips of the nano-structure 104 and the contact surface is influenced by the diameter of nano-structure 104. The van der Waals force occurs between the uncharged atoms of the contact surface and the uncharged atoms of the nano-structure 104. These van der Waals forces occur due to the mutual induction of an electric dipole moment in each atom. These mutually induced electrical dipoles attract the nano-structure 104 to the contact surface and vice versa. The length, shape, and pitch angle between the base 102 and the nano-structure determines the strength of the intermolecular forces. The electrostatic forces develop when a charge imbalance occurs between the surface and the nano-structure 104. The charge imbalance will cause attractive or repulsive forces to develop between the surface and the nano-structure 104.

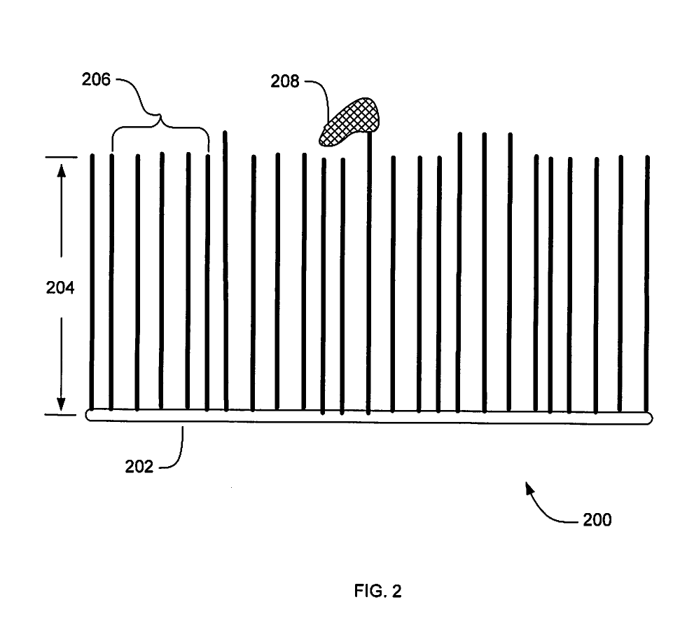

FIG. 2 illustrates a fabricated microstructure 200 in accordance to another embodiment. The fabricated microstructure 200 has a carpet of nano-hairs or nano-structures 206, and a base 202. The height (D) of the nano-structures 206 is shown with reference to label 204. The microstructure 200 as shown also includes a contact surface 208. The contact surface 208 can be a particle, a spec of dust, a rock, or other object that support intermolecular forces between the nano-structure 206 and the contact surface 208. The contact surface is inclusive of other nanostructures, especially nano hairs because when placed too close to one another they tend to clump or self-adhere to neighboring nano hairs. These clump leads to a reduction in the number of nano hairs that can be attached to a surface and that can be used for collecting particles. It should be noted that there could be a plurality of contact surfaces 208 having a variety of sizes and dimensions. Additionally, the microstructure 200 and the contact surface 208 can come into contact under various conditions such as when the nano-structure 208 is gecko hair, then the contact surface is a wall or object where the gecko is using to move from place to place; the contact surface 208 could be surface contaminant that needs to be trapped for analysis or for removal; and the contact surface 208 could be samples, such as particles or dust. The contact surface 208 becomes coupled to the nano-structure on the fabricated microstructure 200. The intermolecular forces keeps the contact surface 208 and the nano-structure coupled until acted upon by a force that breaks the bond between the two.

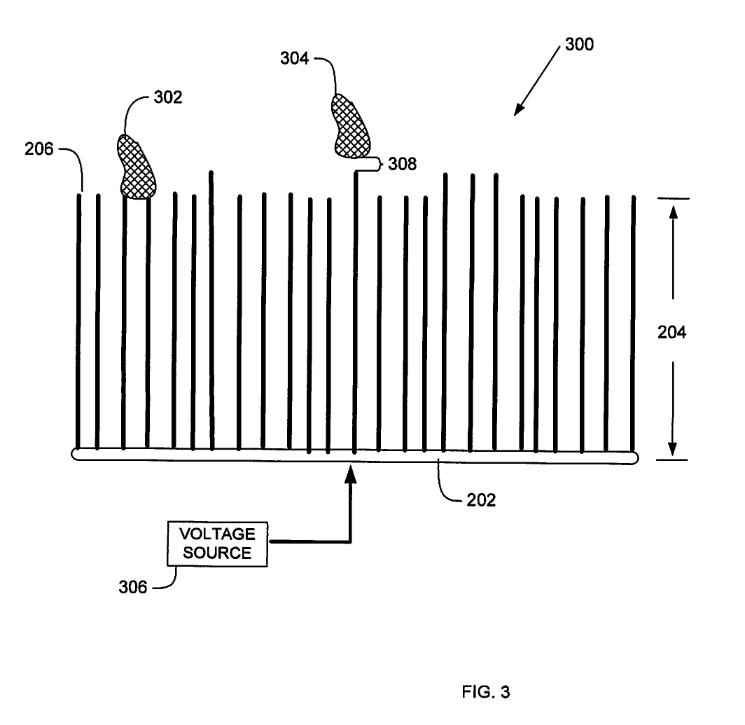

FIG. 3 illustrates a fabricated microstructure 300 with an applied potential 306 in accordance toyet another embodiment. This structure is called a dendritic structure because it appears like a collection of trees in a forest. Further, the structure can also be called a fractal structure because the self-similar structure whose geometrical and topographical features are recapitulated in miniature on finer and finer scales. The contact surface 302 is bound to the nano-structure as noted earlier because of intermolecular forces. Moreover, applied potential (V₀) 306 causes an electric field to travel the height 204 of the nano-structure 206, at the tip of the nano-structure a retardant force is created that could break the intermolecular force. The base 202 of the microstructure acts like a cathode with applied potential V₀ and the contact surface 304 acts as an anode at a higher potential. The force created at the tip of the nano-structure from the applied potential (V₀) causes contact surface 304 to separate from the nano-structure 206. The applied potential (V₀) depends on the geometry and material properties of the contact surface 304 and the nano-structure 206. Thus, the applied potential (V₀) is selected from a range tailored to the application. For example, a voltage in the range of about 0.5 mv to 2.5 mv should be enough to produce an electric field at the tip to repel most contact surfaces. Label 308 illustrates the separation between the nano-structure 206 and the contact surface 304. The relationship of the electric field, the applied potential, and the structure is governed by the following equations:

$$\begin{matrix}{E}_{0} = {V}_{0} / D & EQ . 1 \\ {E}_{0} = {\prod }_{M = 1}^{N} L ( M ) / R ( M ) for 2 \text{-} D & EQ . 2 \\ {E}_{0} = {\prod }_{M = 1}^{N} {( L ( M ) / R ( M ) )}^{2} for 3 \text{-} D & EQ . 3\end{matrix}$$

Applying the above equations to the fabricated microstructure 300 shown in FIG. 3 the electric field gain can be given the successive pitch ratio L/R of steps in the dendritic structure or fabricated microstructure 300. For self-similar structures, we can take the pitch to be constant: L/R=A for all steps M. Then for an N step dendritic structure, the overall gain in electric field is: A×N for 2-D, and, A×2N for 3-D. Taking A=2, and N=20 for 2-D, and N=10 for 3-D, the overall gain is 10×6. Thus for an applied potential of 1 mV, and D=1 mm, the electric field at the tips of the dendritic fractal structure will be 10's of kilovolts/meter after allowing for reductions owing to the finite geometry of the steps. Hence with very small applied voltages, very large electric fields can be generated which can overpower the electrostatic and van der Waals forces that govern the adhesion of dust or other surfaces. The nanotechnology based self similar structure, in either 2-D or 3-D, can be built with a number of steps N suitable for a given application and a desired power consumption levels as dictated by the application power availability. The design is explicitly very low power.

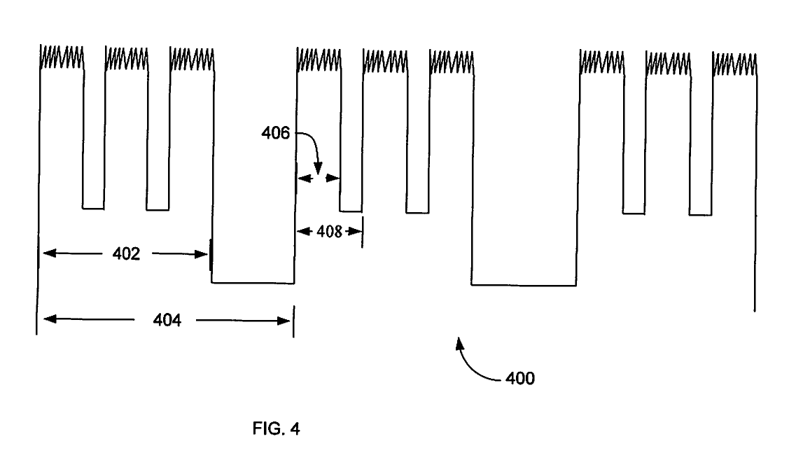

FIG. 4 is an illustration fractal self-similar hair structure 400 for electric field amplification for an N-step structure. The steps are shown with reference to items 402 through 408. Item 402 is the R(M−1), item 404 is L(M−1), item 406 is R(M), and item 408 is L(m). These values can be entered into equations 1 through 3 to arrive at the electric field amplification for the N-step structure.

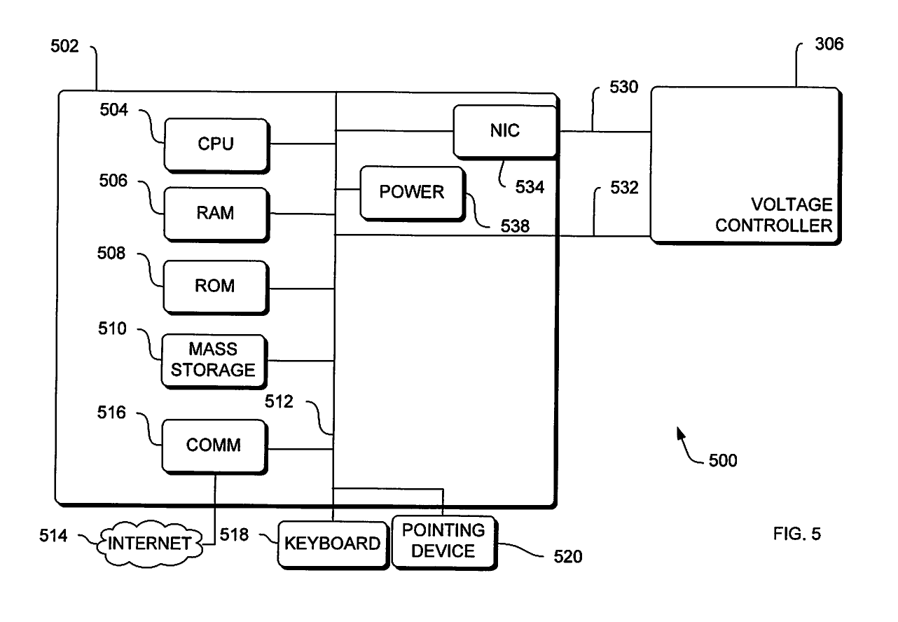

FIG. 5 is a block diagram of a hardware and operating environment 500 in which different embodiments can be practiced. The description below of FIG. 5 provides an overview of computer hardware and a suitable computing environment in conjunction with which some exemplary embodiments can be implemented. For example, exemplary embodiments are described in terms of a computer executing computer-executable instructions. However, some exemplary embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 502 includes a processor 504, commercially available from, for example, Intel, Motorola, Cyrix, and others. Computer 502 also includes random-access memory (RAM) 506, read-only memory (ROM) 508, and one or more mass storage devices 510, and a system bus 512, that operatively couples various system components to the processing unit 504. The memory 506, 508, and mass storage devices 510 are types of computer-accessible media. Mass storage devices 510 are more specifically types of nonvolatile computer-accessible media and can include one or more hard disk drives, floppy disk drives, optical disk drives, and tape cartridge drives. The processor 504 executes computer programs stored on the computer-accessible media.

Computer 502 can be communicatively connected to the Internet 514 via a communication device 516. Internet 514 connectivity is well known within the art. In one embodiment, a communication device 516 is a modem that responds to communication drivers to connect to the Internet via what is known in the art as a “dial-up connection.” In another embodiment, a communication device 516 is an Ethernet® or similar hardware network card connected to a local-area network (LAN) that itself is connected to the Internet via what is known in the art as a “direct connection” (e.g., T1 line, etc.).

A user enters commands and information into the computer 502 through input devices such as a keyboard 518 or a pointing device 520. The keyboard 518 permits entry of textual information into computer 502, as known within the art, and embodiments are not limited to any particular type of keyboard. Pointing device 520 permits the control of the screen pointer provided by a graphical user interface (GUI) of operating systems such as versions of Microsoft Windows™. Embodiments are not limited to any particular pointing device 520. Such pointing devices include mice, touch pads, trackballs, remote controls and point sticks. Other input devices (not shown) can include a microphone, joystick, game pad, satellite dish, scanner, or the like.

In some embodiments, computer 502 is operatively coupled to a display device. Display device is connected to the system bus 512. Display device, permits the display of information, including computer, video and other information, for viewing by a user of the computer. Such display devices include cathode ray tube (CRT) displays (monitors), as well as flat panel displays such as liquid crystal displays (LCD's). In addition to a monitor, computers typically include other peripheral input/output devices such as printers (not shown). Speakers, provide audio output of signals.

Computer 502 also includes an operating system (not shown) that is stored on the computer-accessible media RAM 506, ROM 508, and mass storage device 510, and is and executed by the processor 504. Examples of operating systems include Microsoft Windows®, Apple MacOS®, Linux®, and UNIX®. Examples are not limited to any particular operating system, however, and the construction and use of such operating systems are well known within the art.

Embodiments of computer 502 are not limited to any type of computer 502. In varying embodiments, computer 502 is a PC-compatible computer, a MacOS®-compatible computer, a Linux®-compatible computer, or a UNIX®-compatible computer. The construction and operation of such computers are well known within the art.

Computer 502 can be operated using at least one operating system to provide a graphical user interface (GUI) including a user-controllable pointer. Computer 502 can have at least one web browser application program executing within at least one operating system, to permit users of computer 502 to access intranet or Internet world-wide-web pages as addressed by Universal Resource Locator (URL) addresses. Examples of browser application programs include Netscape Navigator® and Microsoft Internet Explorer®.

The computer 502 can operate in a networked environment using logical connections to one or more remote computers, such as voltage controller 306. These logical connections are achieved by a communication device coupled to, or a part of, the computer 502. Embodiments are not limited to a particular type of communications device. The voltage controller can be another computer, a server, a router, a network PC, a client, a peer device or other common network node. The logical connections depicted in FIG. 5 include a local-area network (LAN) 530 and a wide-area network (WAN) 532 or radio link. Such networking environments are commonplace in offices, enterprise-wide computer networks, intranets and the Internet.

When used in a LAN-networking environment, the computer 502 and remote computer 528 are connected to the local network 530 through network interfaces or adapters 534, which is one type of communications device 516. Remote computer 528 also includes a network device 536. When used in a conventional WAN-networking environment, the computer 502 and remote computer 528 communicate with a WAN 532 through modems (not shown). The modem, which can be internal or external, is connected to the system bus 512. In a networked environment, program modules depicted relative to the computer 502, or portions thereof, can be stored in the remote computer 528.

Computer 502 also includes power supply 538. For example, the power supply 538 can be a battery. Internal and external power supplies are well known in the art.

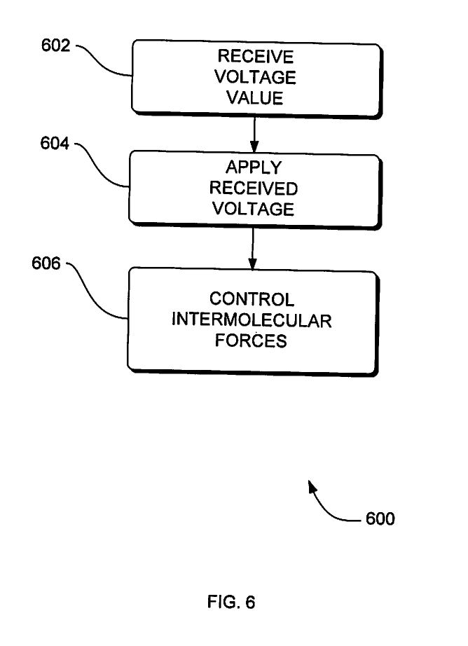

FIG. 6 illustrates a method 600 of applying a potential voltage (V₀) to a fabricated microstructure to cause a contact surface to separate from a nano-structure on the fabricated microstructure in accordance to an embodiment. Method 600 controls the intermolecular forces between the contact surface and the nano-structure by applying a variable potential in accordance to equations 1-3. As noted earlier an electric field can be generated which can overpower the electrostatic and van der Waals forces that govern the adhesion of dust or other surfaces. The nanotechnology based self similar structure, in either 2-D or 3-D, can be built with a number of steps N suitable for a given application and a desired power consumption levels as dictated by the application power availability. An applied voltage in the range of about 0.5 mv to 2.5 mv should be enough to produce an electric field at the tip to repel most contact surfaces.

Method 600 begins with action 602. In action 602, a voltage value is received. The voltage value can be received from an external source such as computer 502, received from the activation of a switch by an operator, or received from internal sources as a command or a set of conditions. After the voltage has been received, control passes to action 604 for further processing. In action 604, the received voltage is applied to the base of the fabricated microstructure. The applied voltage moves from the base through the nano-structure so as to overpower the electrostatic and van der Waals forces that govern the adhesion of dust or other surfaces. In action 606, the intermolecular forces are controlled by application of the received voltage for a certain period of time or until the there is a separation of the surfaces. A major problem with present synthetic gecko hairs has been their tendency to clump or to self-adhere to other hairs, and also to not release after adhering to surface. The fractal system directly addresses these problems by using electric field amplification to repel individual hairs and hence to block clumping, and also to overcome van der Waals adhesion to surfaces and hence to allow the gecko hairs to release as is required for successful application of gecko hairs to mobility and other applications.

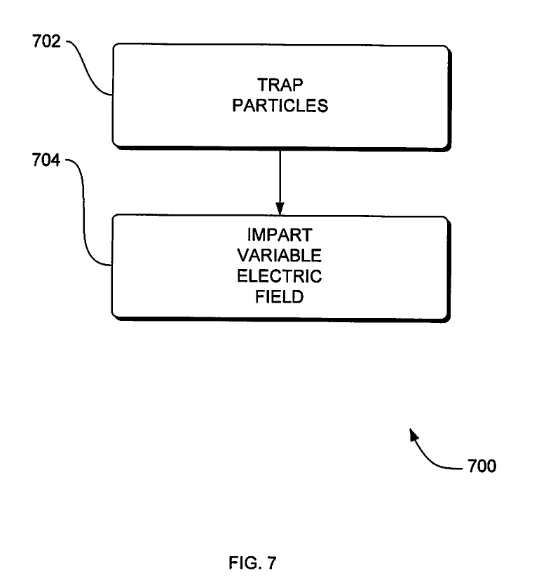

FIG. 7 is an illustration of method 700 of particle or sample collecting with a fabricated microstructure in accordance to an embodiment. Method 700 provides a mechanism for trapping particles or samples for later analysis. In action 702, a carpet of nano hair 300 is used to trap dust or particles at the tip of nano-structures 205. Once trapped these particle can be retrieved by application of a potential field that is amplified until the intermolecular forces between the nano-structure and the contact surface 304 is broken. Method 700 as described above can be used for surface contaminant or dust control at any pressure from that on Earth of about 1 bar, to Mars at several millibars, to the Moon at high vacuum, and for dust sample collection in planetary contexts using a tool coated with the fractal fabric system.

A device for controlling intermolecular forces is described. Although specific embodiments are illustrated and described herein, it will be appreciated by those of ordinary skill in the art that any arrangement which is calculated to achieve the same purpose may be substituted for the specific embodiments shown. This application is intended to cover any adaptations or variations.

I claim:

1. An apparatus for controlling intermolecular forces at a contact surface, the apparatus comprising:
a fabricated microstructure comprising:
a base;
at least one or more nano-structures disposed on one or more portions of the base to adhere to the contact surface, wherein the nano-structures have variable lengths and are anchored to the base; and
generator for imparting a variable electric field at the base, wherein the imparted electric field controls the intermolecular forces between the nano-structures and the contact surface.

2. The apparatus of claim 1, wherein the nano-structures form one of a fractal and dendritic architecture of needle-like points.

3. The apparatus of claim 2, wherein the one or more nano-structures adhere to the contact surface by intermolecular forces.

4. The apparatus of claim 3, wherein the intermolecular forces are van der Waals forces.

5. The apparatus of claim 3, wherein the intermolecular forces are electrostatic forces.

6. The apparatus of claim 3, wherein the imparted variable electric field travels from the base through the one or more nano-structures.

7. The apparatus of claim 3, wherein the imparted variable electric field causes a reduction in the intermolecular forces.

8. The apparatus of claim 3, wherein the imparted variable electric field breaks the contact between the one or more nano-structures and the contact surface.

9. A method for sampling one or more particles comprising:
trapping the one or more particles in a fabricated microstructure, wherein the microstructure has a base and one or more nano-structures disposed on one or more portions of the base to adhere to the one or more particles through intermolecular forces formed between the one or more nano-structures and the one or more particles; and
imparting a variable electric field at the base, wherein the imparted electric field controls the intermolecular forces between the nano-structures and the one or more particles.

10. The method of claim 9, wherein the nano-structures form a fractal or dendritic architecture of needle-like points; and
wherein the nano-structures have variable lengths and are anchored to the base.

11. The method of claim 10, wherein the intermolecular forces are van der Waals forces.

12. The method of claim 10, wherein the intermolecular forces are electrostatic forces.

13. The method of claim 10, wherein the imparted variable electric field travels from the base through the one or more nano-structures.

14. The method of claim 10, wherein the imparted variable electric field causes a reduction in the intermolecular forces.

15. The method of claim 10, wherein the imparted variable electric field breaks the contact between the one or more nano-structures and the one or more particles.

16. A method for cleaning a surface having particulate matter thereon, the surface being a fabricated microstructure having a base and one or more nano-structures disposed on one or more portions of the base, wherein the nano-structures have variable lengths and are anchored to the base, the method comprising:
controlling intermolecular forces between the nano-structures and the particulate matter by imparting an electric field at the base;
wherein the intermolecular forces cause the one or more nano-structures to adhere to the particulate matter.

17. The method of claim 16, wherein the nano-structures form a fractal or dendritic architecture of needle-like points.

18. The method of claim 17, wherein the intermolecular forces are van der Waals forces.

19. The method of claim 17, wherein the intermolecular forces are electrostatic forces.

20. The method of claim 17, wherein the imparted variable electric field travels from the base through the one or more nano-structures.

21. The method of claim 17, wherein the imparted variable electric field causes a reduction in the intermolecular forces.

22. The method of claim 17, wherein the imparted variable electric field breaks the contact between the one or more nano-structures and the contact surface.
